(19) United States
(12) Patent Application Publication
(10) Pub. No.: US 2023/0004632 A1
(43) Pub. Date: Jan. 5, 2023

(54) FACE AUTHENTICATION SYSTEM

(71) Applicant: Hitachi-LG Data Storage, Inc., Tokyo (JP)

(72) Inventors: Takaaki UENO, Tokyo (JP); Takuya NAKAMICHI, Tokyo (JP)

(21) Appl. No.: 17/839,713

(22) Filed: Jun. 14, 2022

(30) Foreign Application Priority Data
Jun. 30, 2021 (JP) 2021-108593

(51) Int. Cl. G06F 21/32

(52) U.S. Cl. CPC G06F 21/32

(57) ABSTRACT

The invention provides a face authentication system robust to the individual differences in the face parts or changes in the face orientation when an individual is identified by using a face image in a state of wearing a wearable item. The face authentication system according to the invention identifies an individual by using a synthesized image obtained by deforming a wearable item image to fit a face shape of the individual.

### CROSS-REFERENCE TO RELATED APPLICATION

The present application claims priority from Japanese application JP2021-108593, filed on Jun. 30, 2021, the contents of which is hereby incorporated by reference into this application.

### BACKGROUND OF THE INVENTION

### 1. Field of the Invention

The present invention relates to a face authentication system that identifies an individual by using a face image.

### 2. Description of the Related Art

Face authentication technique, as one example of biometrics authentication using biometric information, is a technique of registering a face image of an individual user in advance and collating a face image extracted at the time of authentication with the face image registered in advance to determine whether the person matches. The face authentication technique can take the face image from a remote location, and thus has an advantage that the authentication can be performed in a non-contact manner without requiring any authentication operations by the user as in fingerprint authentication or the like. The face authentication has been widely used for access management in offices, educational institutions, event venues, or for surveillance security using surveillance camera images, or the like.

In particular, in recent years, due to the influence of COVID-19, the need to verify identity while wearing masks and goggles has increased, and a system that can perform face authentication even when the person is wearing a mask or other wearable items is required.

In response to the above problems, for example, JP-A-2015-088095 discloses a technique of using an image obtained by synthesizing a wearable item image of a mask, a hat or the like with a real face image into a face image for registration used at the time of collation, so as to reduce burdens on a user at the time of registration and perform face authentication while the user is wearing a wearable item.

### SUMMARY OF THE INVENTION

The method described in JP-A-2015-088095 synthesizes a wearable item image as it is into a real face image, and thus cannot generate a wearable item image that corresponds to individual differences in face parts (structure, size, shape, etc.) and changes in face orientation (rotation to angles in a yaw, roll, or pitch direction), and has poor robustness to the changes in face conditions. In addition, in applications such as simultaneous authentication of multiple individuals using signage and face authentication using surveillance cameras, it is assumed that the face orientation at the time of authentication is not limited to the front face but is in various directions. Thus, a face authentication system having high robustness for the face orientation is desired.

The invention has been made in view of the above problems, and has an object to provide a face authentication system robust to the individual differences in the face parts or changes in the face orientation when an individual is identified by using a face image in a state of wearing a wearable item.

The face authentication system according to the invention identifies an individual by using a synthesized image obtained by deforming a wearable item image to fit the wearable item image with a face shape of the individual.

According to the face authentication system according to the invention, it is possible to provide a highly accurate face authentication system that can improve robustness to individual differences in face parts or changes in face orientation when an individual is to be identified by using a face image in a state of wearing a wearable item.

### BRIEF DESCRIPTION OF THE DRAWINGS

FIG. 1 is a block diagram showing an overall configuration of a face authentication system 1 according to a first embodiment.

FIG. 2A is an example of a real face image 401.

FIG. 2B is an example of a wearable item image 402.

FIG. 2C is an example of a synthesized image 403.

FIG. 3 is a block diagram showing an internal configuration of a face image registration unit 220 and a face image collation unit 320.

FIG. 4 is a flowchart illustrating a process of registering the real face image 401 at the time of face registration.

FIG. 5 is a diagram showing a process of generating the synthesized image 403 from the real face image 401.

FIG. 6 is a flowchart illustrating a process of generating the synthesized image 403 from the real face image 401 and recording the synthesized image 403 in a data storage unit 400.

FIG. 7 is a flowchart illustrating a process at the time of face authentication.

FIG. 8A is a diagram showing a comparison result of a similarity when the face is tilted in a yaw direction from the front.

FIG. 8B is a diagram showing a comparison result of the similarity when the face is tilted in a roll direction from the front.

FIG. 9 is a diagram showing a detailed configuration of the face authentication system 1 in a second embodiment.

FIG. 10 is a flowchart illustrating a process at the time of face registration in the second embodiment.

FIG. 11 is a flowchart illustrating a process at the time of face authentication in the second embodiment.

FIG. 12 is a configuration diagram of the face authentication system 1 according to a third embodiment.

FIG. 13 is a diagram showing an internal processing block of the face authentication system 1.

FIG. 14 is a flowchart illustrating a process of generating and registering the synthesized image 403 at the time of face registration.

FIG. 15 is a configuration diagram of a face authentication unit 300 in the third embodiment.

FIG. 16 is a flowchart showing operations at the time of face authentication in the third embodiment.

FIG. 17 is a configuration diagram of the face authentication unit 300 in a fourth embodiment.

FIG. 18 is a flowchart illustrating operations at the time of authentication in the fourth embodiment.

FIG. 19 is a configuration diagram of a face registration unit 200 in a fifth embodiment.

FIG. 20 is a diagram showing the effect of the fifth embodiment.

FIG. 21 is a configuration diagram of the face authentication unit 300 in the fifth embodiment.

### DESCRIPTION OF THE PREFERRED EMBODIMENTS

### First Embodiment

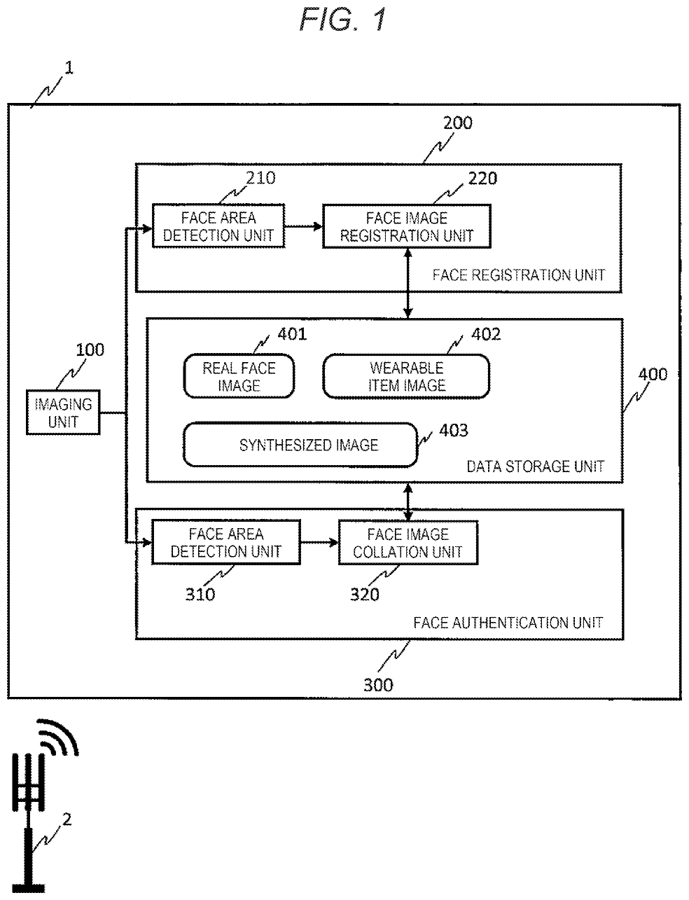

FIG. 1 is a block diagram showing an overall configuration of a face authentication system 1 according to a first embodiment of the invention. The face authentication system 1 is a system for identifying an individual by using a face image. The face authentication system 1 includes an imaging unit 100, a face registration unit 200, a face authentication unit 300, and a data storage unit 400.

The face registration unit 200 includes a face area detection unit 210 and a face image registration unit 220. The face authentication unit 300 includes a face area detection unit 310 and a face image collation unit 320. The data storage unit 400 stores a real face image 401, a wearable item image 402, and a synthesized image 403. The face registration unit 200 and the face authentication unit 300, as will be described later, may both generate the synthesized image 403 by synthesizing the real face image 401 and the wearable item image 402, and can serve as a “synthesis unit” for generating the synthesized image 403.

The imaging unit 100 may any one that is capable of acquiring a two-dimensional image in which luminance information is stored in an xy-direction, or a three-dimensional image in which distance (depth) information in a z-direction is stored in addition to the luminance information in the xy direction.

The synthesized image 403 is obtained by processing the wearable item image 402 to fit the real face image 401 and synthesizing the wearable item image 402 with the real face image 401. A processing example will be described later. A plurality of synthesized images 403 may be stored for each type of external wearable items such as mask, glasses, sunglasses, goggles, and hat. When the same type of wearable items has a plurality of shape patterns, the synthesized image 403 may be generated for each shape pattern. For example, as the wearable item, a mask may be a flat mask or a three-dimensional mask, and glasses may have square lenses or round lenses. Further, a plurality of types of external wearable items may be simultaneously synthesized. For example, masks and goggles may be simultaneously synthesized. In the invention, the real face image 401, the wearable item image 402, and the synthesized image 403 may be two-dimensional images or three-dimensional images, and may be feature vector quantities instead of images.

The face authentication system 1 may include two or more data storage units 400, and may use the data storage units 400 properly according to the type of data. For example, the real face image 401, the wearable item image 402, and the synthesized image 403 may be registered in different external data storage units 400 and received wirelessly from a data base station 2.

Operations at the time of face registration will be explained. An image captured by the imaging unit 100 is sent to the face area detection unit 210 in the face registration unit 200. The face area detection unit 210 extracts a real face image from the captured image and inputs the real face image to the face image registration unit 220. The face image registration unit 220 records the input real face image as registered face data of the user in the data storage unit 400. The registered face data refers to the real face image 401 and the synthesized image 403, which may be recorded alone or simultaneously. A plurality of types of the synthesized images 403 may be simultaneously recorded depending on the types of the wearable items.

Operations at the time of face authentication will be explained. An image captured by the imaging unit 100 is sent to the face area detection unit 310 in the face authentication unit 300. The face area detection unit 310 extracts a face image from the captured images and inputs the face image to the face image collation unit 320. The face image extracted by the face area detection unit 310 may be either a real face or a case of wearing a wearable item, depending on the face condition of the user at the time of authentication. The face image collation unit 320 acquires one or more of the real face images 401 or the synthesized images 403 from the data storage unit 400. The face image collation unit 320 performs a face image collation process between each piece of the acquired registered face data and each of the face images extracted from the captured images at the time of authentication, and outputs an authentication result of the collation to an output device or another system. Specifically, the face image collation unit 320 calculates a similarity between each of the face images extracted by the face area detection unit 310 and each piece of one or more registered face data acquired from the data storage unit, and the user is authenticated as a registered user when any of the similarities reaches a specified level.

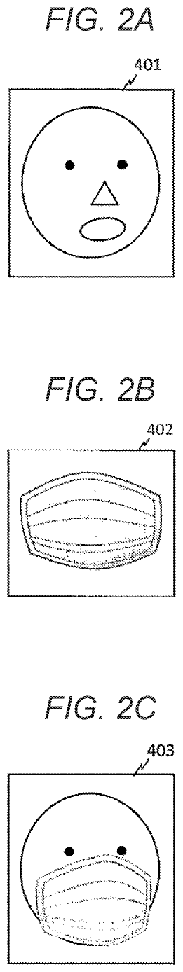

FIG. 2A is an example of the real face image 401. The real face image 401 is a face image without wearing external wearable items, and is taken as a real face image even when the captured subject is wearing make-up or the like.

FIG. 2B is an example of the wearable item image 402. The wearable item image 402 is an image of a single wearable item. The wearable item mentioned here is an external artificial object such as a mask, sunglasses, goggles, glasses, a hat, etc. that is worn to the real face (the head of the person to be authenticated), and is an object that hinders face authentication.

FIG. 2C is an example of the synthesized image 403. The synthesized image 403 is obtained by processing the wearable item image 402 to fit the face parts and the orientation of the face, and synthesizing the wearable item image 402 to fit the real face image 401. For example, when the real face image 401 is rotated about a yaw axis, the synthesized image 403 can be generated by similarly rotating the wearable item image 402 around the yaw axis and synthesizing the wearable item image 402 with the real face image 401.

The present embodiment can be applied to either 1:1 authentication that is a one-to-one relation between input biometric information and biometric information to be collated, or 1:N authentication that is a one-to-N relation in which each piece of input biometric information corresponds to multiple pieces of the biometric information to be compared. In an example of 1:1 authentication using a card and biometric information, input biometric information is collated with biometric information registered in the card. In the 1:N authentication, input biometric information is sequentially compared with all biometric information registered in a database, and the closest user is uniquely identified.

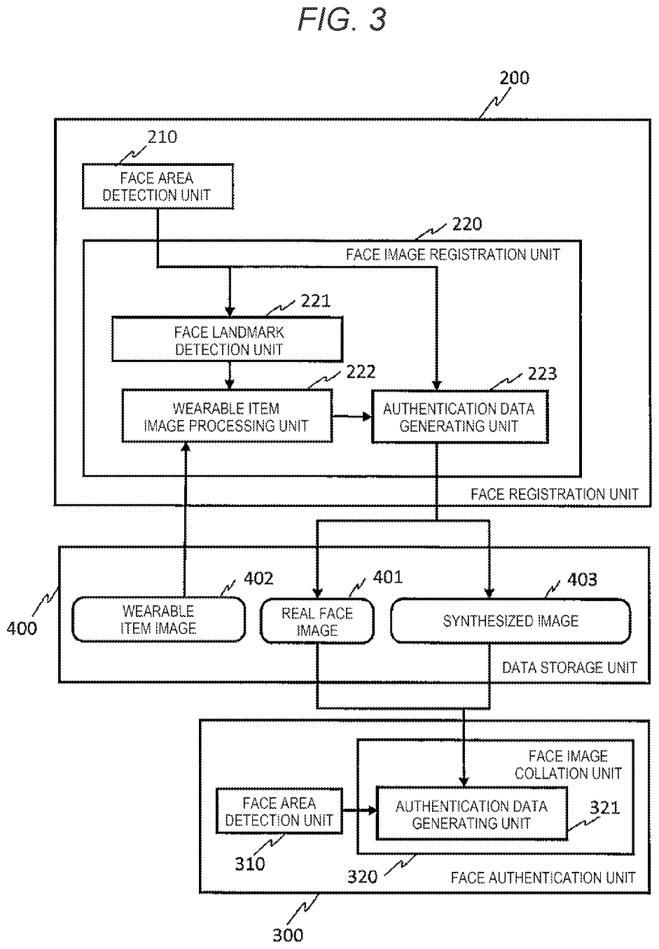

FIG. 3 is a block diagram showing an internal configuration of the face image registration unit 220 and a face image collation unit 320. The face image registration unit 220 includes a face landmark detection unit 221, a wearable item image processing unit 222, and an authentication data generating unit 223. The face image collation unit 320 includes an authentication data generating unit 321. Operations of these functional units will be described later.

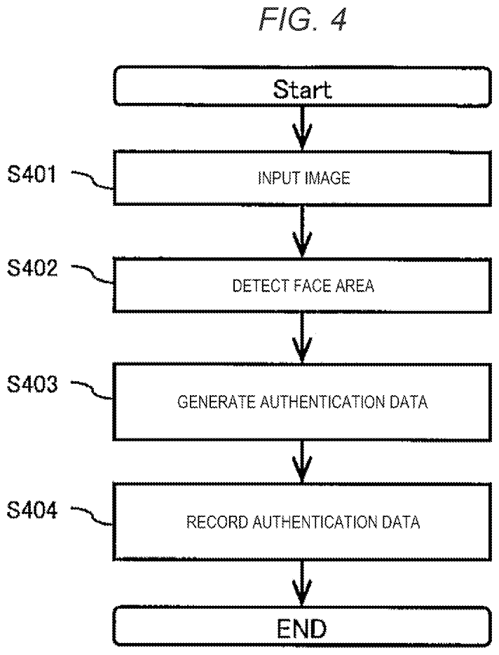

FIG. 4 is a flowchart illustrating a process of registering the real face image 401 at the time of face registration. An image captured by the imaging unit 100 is input to the face area detection unit 210 (S401). The face area detection unit 210 extracts a face area of the user to be registered from the captured image to generate the real face image (S402). The generated real face image is sent to the authentication data generating unit 223. The authentication data generating unit 223 generates authentication data based on the real face image (S403) and records the real face image in the data storage unit 400 (S404). The authentication data may be the synthesized image 403 per se, or a feature of the synthesized image 403 may be used as the authentication data. In the former case, the synthesized image 403 and the captured image are collated, and in the latter case, the feature of the synthesized image 403 and the feature of the captured image are collated.

In S402, an image area corresponding to the face area is specified from the luminance information (or the distance information or a combination thereof) in the captured image, and the image area is cut out from the captured image to generate the face image. In S402, when the face image is generated from the face area cut out from the captured image, one or more processing steps for processing the face image into a more appropriate state for the face authentication may be included. For example, image size conversion, image rotation, affine transformation, face orientation angle deformation by non-rigid body deformation method based on free-form deformation (FFD) method or the like, removal of noise and blur contained in the face image, contrast adjustment, distortion correction, background area removal, and the like can be used.

As the face area detection processing method in S402, a known method can be used. For example, Viola-Jopnes method using Haar-like features or a detector based on a neural network (hereinafter referred to as NN) model can be used.

The authentication data generated in S403 is converted into a format suitable for the algorithm adopted by the face authentication unit 300, and may be a feature vector quantity or be in the form of an image. An example of generating a feature vector will be described below. The authentication data generating unit 223 inputs the received real face image into a predetermined feature extractor to generate a feature vector representing a feature of the face image. Examples of the feature extractor may be an algorithm based on an NN model trained by training data, an algorithm based on local binary patterns, or the like. A plurality of face images for registration may be simultaneously input to the feature extractor to generate an integrated feature vector quantity. For example, a combination of the real face image 401 and the plurality of types of synthesized images 403 is simultaneously input to the feature extractor to generate the feature vector. The feature vector quantity may be a sum of products calculated by respectively multiplying the feature vectors corresponding to the plurality of face images for registration with predetermined weights.

In S404, when data is recorded in the data storage unit 400, an encryption process or the like for improving security may be performed.

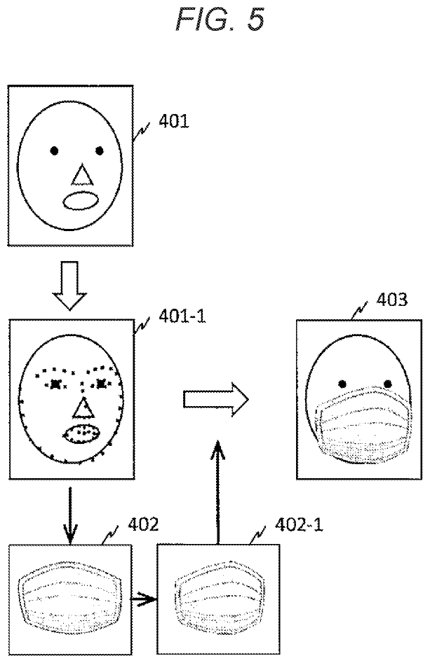

FIG. 5 is a diagram showing a process of generating the synthesized image 403 from the real face image 401. The face landmark detection unit 221 detects face landmarks 401-1 from the real face image 401. The face landmarks are reference points on the face image. The wearable item image processing unit 222 generates a processed wearable item image 402-1 by deforming the wearable item image 402 to fit the positions of the face landmarks 401-1. The authentication data generating unit 223 generates the synthesized image 403 by synthesizing the real face image 401 and the processed wearable item image 402-1. The synthesizing procedure is as follows.

### Synthesizing Procedure: 1

The face landmark detection unit 221 detects a rotation angle of the face (a combination of one or more of yaw, roll, and pitch) based on the face landmarks. The wearable item image processing unit 222 rotates the wearable item image 402 to match the rotation angle of the face.

### Synthesizing Procedure: 2

The wearable item image processing unit 222 deforms the wearable item image such that a vertical size of the wearable item image 402 matches a vertical size of a wearing position among the face landmarks where the wearable item is worn. For example, a distance between the top portion of a mask (the most protruding part of the portion covering the nose) and the bottom portion of the mask can be the vertical size of the wearable item image 402. For example, a distance between a third point from the top among nose landmarks and a point located at the chin tip among chin landmarks can be the vertical size of the wearing position. The wearable item image 402 is aligned such that both the sizes match with each other. If necessary, affine transformation, homography transformation, or a combination thereof may be used.

### Synthesizing Procedure: 3

The wearable item image processing unit 222 deforms the wearable item image such that a horizontal size of the wearable item image 402 matches a horizontal size of the wearing position where the wearable item is worn among the face landmarks. For example, a distance between the left and right ends of the mask can be the horizontal size of the wearable item image 402. For example, the distance between the face landmarks on the left and right ends can be set as the horizontal size of the wearing position. The wearable item image 402 is aligned such that both the sizes match with each other. If necessary, affine transformation, homography transformation, or a combination thereof may be used.

### Synthesizing Procedure: 4

The wearable item image processing unit 222 may divide the wearable item image 402 into a plurality of areas to perform the above steps 2 and 3. For example, the wearable item image 402 may be divided into a right half and a left half. That is, the wearable item image 402 may be deformed in the left half and the right half to match the vertical size of the wearable item image 402 with the vertical size of the wearing position, and match the horizontal size of the wearable item image 402 with the horizontal size of the wearing position. The horizontal size in this case can be, for example, a distance from a point to a straight line from a straight line connecting the third point from the top among the nose landmarks and the point located at the chin tip among the chin landmarks, to a right end (or left end) point among the face landmarks. For example, when the image is not symmetrical with respect to the center of rotation as the processed wearable item image 402-1, it is useful to carry out individual deformation for each of the left half and the right half of the wearable item image 402 in this way.

### Synthesizing Procedure: Supplement 1

The above is an example of the case where the wearable item is a mask, but can also be used for other wearable items. That is, after matching the rotation angle of the face with the rotation angle of the wearable item, the wearable item image 402 may be deformed to match the vertical/horizontal size of the wearable item with the vertical/horizontal size of the wearing position. The wearing position may be appropriately determined for each type of the wearable item. The same procedure can be used for rotations other than the yaw rotation.

### Synthesizing Procedure: Supplement 2

The above is an example in which the wearable item image 402 is rotated to match the rotation angle of the face, and then is synthesized to match the vertical/horizontal size of the wearable item and the wearing position. The procedures, however, may be interchanged to determine in advance the vertical/horizontal size of the wearable item according to the wearing position, and then perform the rotation process to synthesize the images.

Other than the above synthesizing procedure example, a synthesizing procedure may be performed by providing a plurality of control points inside the wearable item image 402 and non-linearly deforming the image to match the control points with reference points of the wearing position determined based on the face landmarks. If necessary, this synthesizing procedure may be combined with the above synthesizing procedure example.

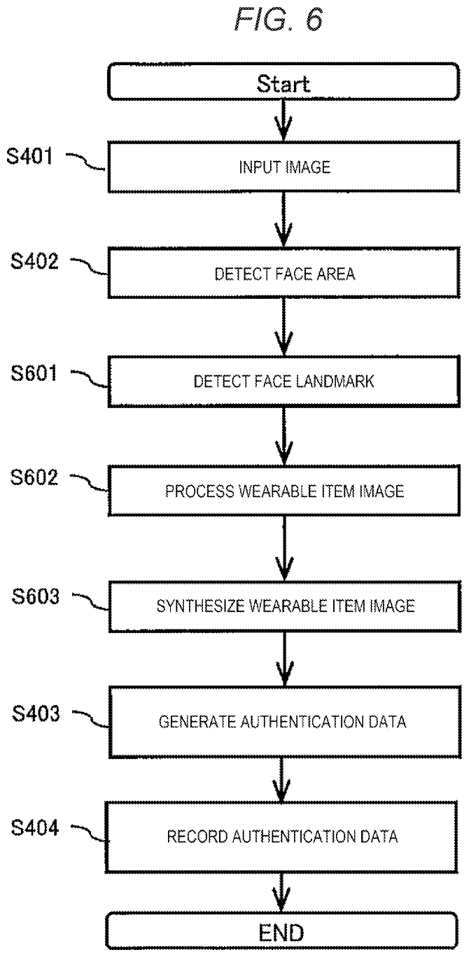

FIG. 6 is a flowchart illustrating a process of generating the synthesized image 403 from the real face image 401 and recording the synthesized image 403 in the data storage unit 400. In FIG. 6, steps having the same functions as those in FIG. 4 are designated by the same reference numerals, and detailed description thereof will be omitted. Here, an example in which the wearable item image 402 is a mask will be described. In the flowchart of FIG. 6, S601, S602, and S603 are added as compared to FIG. 4. These steps will be described below.

### FIG. 6: Step S601

The real face image 401 extracted in S402 is input to the face landmark detection unit 221. The face landmark detection unit 221 detects the face landmarks 401-1 from a face area. The face landmarks 401-1 are feature points indicating the position of each part of the face such as eyes, eyebrows, nose, mouth, chin, and contour. The face landmarks 401-1 in FIG. 5 show an example in which 68 feature points of face parts are detected, but as long as at least one position of the face part is detected, the position can be used as the face landmark 401-1. Known methods can be used as the face landmark detection method. For example, a method using pattern matching based on active appearance model, a feature point extraction method based on regression trees, or a detector based on an NN model can be used. Information of the real face image 401 generated in S402 and face landmarks 401-1 detected in S601 is input to the wearable item image processing unit 222.

### FIG. 6: Step S602

The wearable item image processing unit 222 acquires the wearable item image 402 stored in the data storage unit 400 in advance, and generates the processed wearable item image 402-1 by processing the wearable item image 402 based on the face landmarks 401-1.

### FIG. 6: Step S603

The authentication data generating unit 223 generates the synthesized image 403 by synthesizing the processed wearable item image 402-1 to fit the real face image 401, and stores the synthesized image 403 in the data storage unit 400.

Although one wearable item image 402 acquired in S602 is used in the above example, a plurality of images may be acquired depending on the type of the wearable item image, and the synthesized image 403 may be generated for each type of the wearable item image and for each shape pattern of the same type of the wearable item. For example, the synthesized image 403 in which a plurality of types of wearable items are simultaneously worn may be generated, as in the case where a mask and goggles are simultaneously synthesized with the real face image 401.

In the above method, the synthesized image 403 is automatically generated from the real face image 401, and thus, the user only needs to register the real face image 401 without necessity of capturing an image while wearing the wearable item, and the burdens on the user at the time of registration can be reduced. At the time of face authentication, by matching the face image extracted from the face area detection unit 310 with each of the real face image 401 and the synthesized image 403 stored in the data storage unit 400, face authentication is possible even when the user is wearing a wearable item at the time of face authentication. The synthesized image 403 is obtained by processing the wearable item image 402 based on the structure of the face parts, the size of each face part, the shape of each face part, the shape of the contour of the face, and the like in the real face image 401 registered by the user and synthesizing the wearable item image 402 and the real face image 401. Therefore, regardless of the individual difference of the face parts for different users and the face orientation such as the rotation angle in the yaw, roll, or pitch direction, the accuracy of deriving the similarity is improved, which enables highly accurate face authentication which is robust to changes in the face conditions.

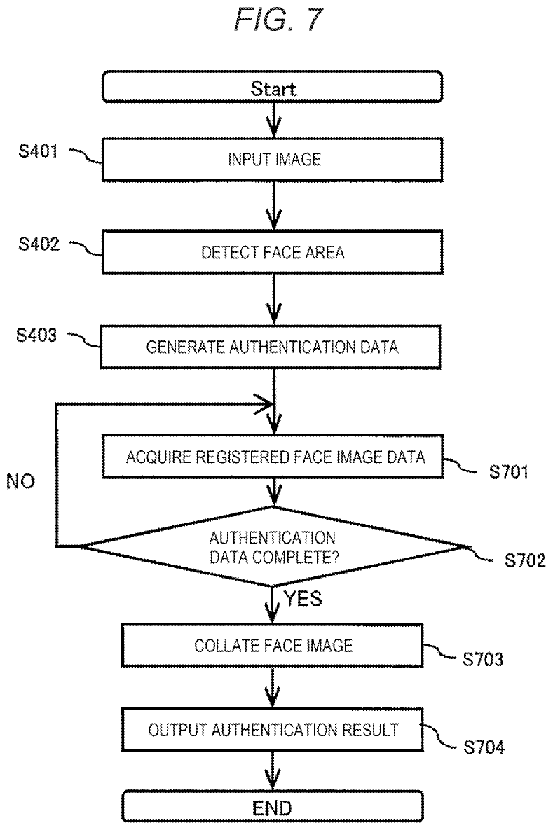

FIG. 7 is a flowchart illustrating a process at the time of face authentication. S701 to S704 are added as compared to FIG. 4. In the following, the steps added to FIG. 4 will be mainly described.

### FIG. 7: Steps S401 to S403

At the time of face authentication as well, similar to the time of face registration, a face image generated by the face area detection unit 310 is input to the authentication data generating unit 321 in the face image collation unit 320, and the authentication data generating unit 321 generates the authentication data.

### FIG. 7: Steps S701 to S703

The face authentication unit 300 acquires the real face image 401 and the synthesized image 403 for collating with the face image acquired at the time of face authentication from the data storage unit 400 (S701). In that case, the face authentication unit 300 confirms whether the authentication data of the face image acquired at the time of face authentication and the authentication data acquired from the data storage unit 400 are complete (S702). If the authentication data is not complete, the process returns to S701 again. When the authentication data is complete, the face image acquired at the time of authentication and the plurality of pieces of registered face data acquired from the data storage unit 400 are compared with each other by calculating the similarity (S703).

### FIG. 7: Steps S702: Supplement

The authentication data being complete means that the authentication data has already been generated for all the individuals assumed by the face authentication system 1 as the individuals to be authenticated.

### FIG. 7: Steps S703: Supplement 1

As an example of calculating the similarity, when the authentication data is feature vector quantities, a known method such as Euclidean norm, cosine similarity, or the like can be used. In the similarity calculation of a pixel set such as a two-dimensional image or a three-dimensional image, a known method based on block matching, a method based on luminance distribution vector of the image, or the like can be used. In the authentication based on the feature vector quantity, the calculation amount is generally reduced as compared to the case of using the pixel set, and thus the similarity calculation using the feature vector quantity is more effective when it is desired to speed up the collation process.

### FIG. 7: Steps S703: Supplement 2

In this step, two or more among the feature vector quantity, the two-dimensional image, and the three-dimensional image may be synthesized to comprehensively calculate the similarity. For example, when the feature vector quantity and the two-dimensional image are used, predetermined similarities may be calculated for each, and a value finally summed based on predetermined weights may be used as the similarity.

### FIG. 7: Step S704

The face authentication unit 300 performs the face authentication by confirming whether the calculated similarity satisfies a condition of a predetermined threshold value. The face authentication unit 300 outputs the authentication result to the output device, another system, or the like. For example, the following can be used as the authentication method. In the case of the 1:1 authentication, the user is a registered user when the calculated similarity satisfies the condition of the predetermined threshold value. It is determined that “the person does not match” when the condition of the threshold value is not satisfied. In the case of the 1:N authentication, the registered user who has the largest calculated similarity and satisfies the condition of the predetermined threshold value is determined to be the user. It is determined as “unregistered” when the condition of the threshold value is not satisfied.

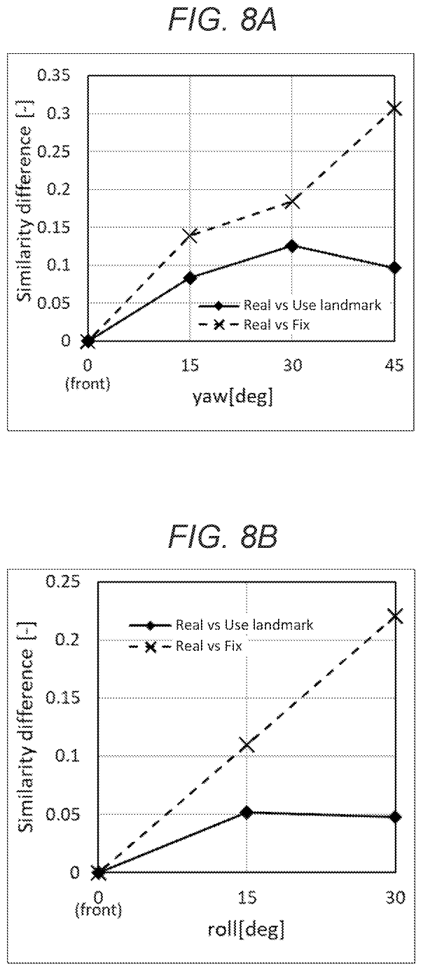

FIG. 8A to 8B show results of comparing a case of authentication using the synthesized image 403 generated by processing the wearable item image 402 based on the face landmarks in the invention to fit the real face image 401 and a case where the wearable item image 402 is not processed and is directly synthesized with the real face image 401 to perform the authentication. Here, the wearable item image was a mask, and the same person was compared. At the time of registration, a real face image facing a specific angle is registered, and the mask is synthesized based on a predetermined method. At the time of authentication, a real mask was worn, and the face was turned at the predetermined angle, and the similarity with the face image after synthesizing the mask was calculated. A feature vector generated from a feature extractor based on an NN model was used for the authentication data, and Euclidean norm was used for the calculation of the similarity. The vertical axis shows a relative similarity for each face angle with the similarity when the authentication is performed facing the front as 0. A smaller similarity indicates more accurate detection.

FIG. 8A is a diagram showing a comparison result of the similarity when the face is tilted in the yaw direction from the front, and FIG. 8B is a diagram showing a comparison result of the similarity when the face is tilted in the roll direction from the front. The dotted line shows the result without processing the wearable item image, and the solid line shows the result applied with the wearable item image processing of the invention. The similarity when the synthesized image 403 generated based on the face landmarks is used at the time of authentication is smaller than the case without processing the wearable item. In particular, looking at the graph with respect to the angle in the roll direction, the difference in the similarity is about 0.05, and the invention tends to be particularly effective in the roll direction. On the other hand, when the wearable item image 402 is synthesized as it is without being processed according to the face parts and orientation, the difference in the similarity tends to increase as the angle of the face orientation increases, and setting a certain threshold value adversely affects the authentication accuracy (for example, in a case where the threshold value of the similarity is 0.15, when the face rotates more than a certain amount from the front in either the yaw direction or the roll direction, the similarity reaches the threshold value and it is determined that “the person does not match”). Thus, it can be seen that the invention can reduce the influence on the derivation of the similarity even when the angle of the face changes, and can improve the robustness to the angle of the face orientation.

### Second Embodiment

A second embodiment of the invention will describe a configuration example in which a pattern of a wearable item is detected to determine whether a wearable item is worn, and when the wearable item is worn, the wearable item image 402 corresponding to the pattern is synthesized.

Here, a wearable item shape pattern includes not only the type of the wearable item (mask, glasses, goggles, etc.) but also those having different shapes even in the same type of the wearable item (for example, a mask may be a flat mask, a three-dimensional mask, a children's mask, a women's mask, etc.).

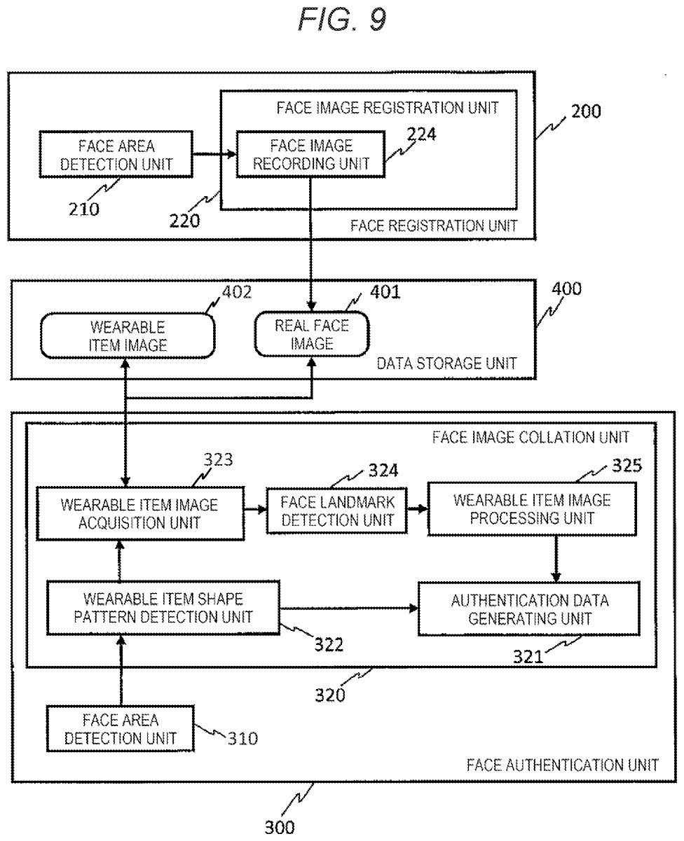

FIG. 9 is a diagram showing a detailed configuration of the face authentication system 1 in the second embodiment. Compared to the first embodiment shown in FIG. 3, the internal configurations of the face image registration unit 220 and the face image collation unit 320 are different. Others are the same as those in the first embodiment.

The face image registration unit 220 has a face image recording unit 224 in an internal block. The face image collation unit 320 includes an authentication data generating unit 321, a wearable item shape pattern detection unit 322, a wearable item image acquisition unit 323, a face landmark detection unit 324, and a wearable item image processing unit 325. The description of the blocks having the same process as the blocks of the first embodiment will be omitted, and only the internal process of the face image registration unit 220 and the face image collation unit 320 will be described.

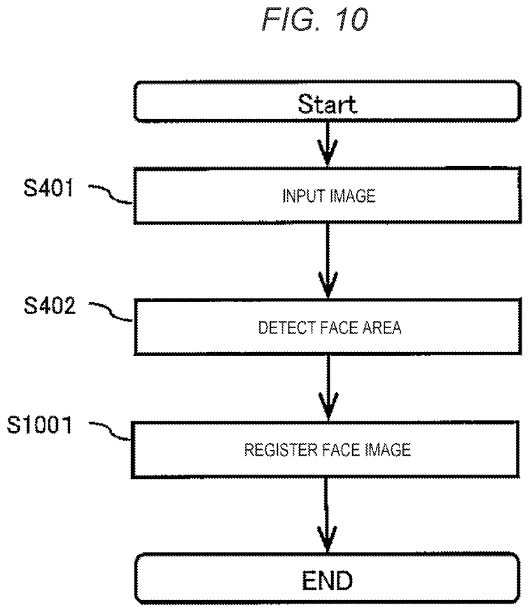

FIG. 10 is a flowchart illustrating a process at the time of face registration in the second embodiment. The same steps as those in the first embodiment are designated by the same reference numerals, and the description thereof will be omitted. In S1001, the real face image generated by the face area detection unit 210 is sent to the face image recording unit 224 in the face image registration unit 220 and registered in the data storage unit 400. In this case, the form of the real face image to be registered may be the two-dimensional image or the three-dimensional image. If the feature vector quantity is required at the time of authentication, S403 may be added after S402 to generate the feature vector using the feature extractor, or the real face image may be simultaneously recorded with the above data in the form of an image. When the real face image is recorded in the data storage unit 400 in the form of an image, the face image to be registered may be subjected to a lossless compression process before recording in order to reduce the data capacity.

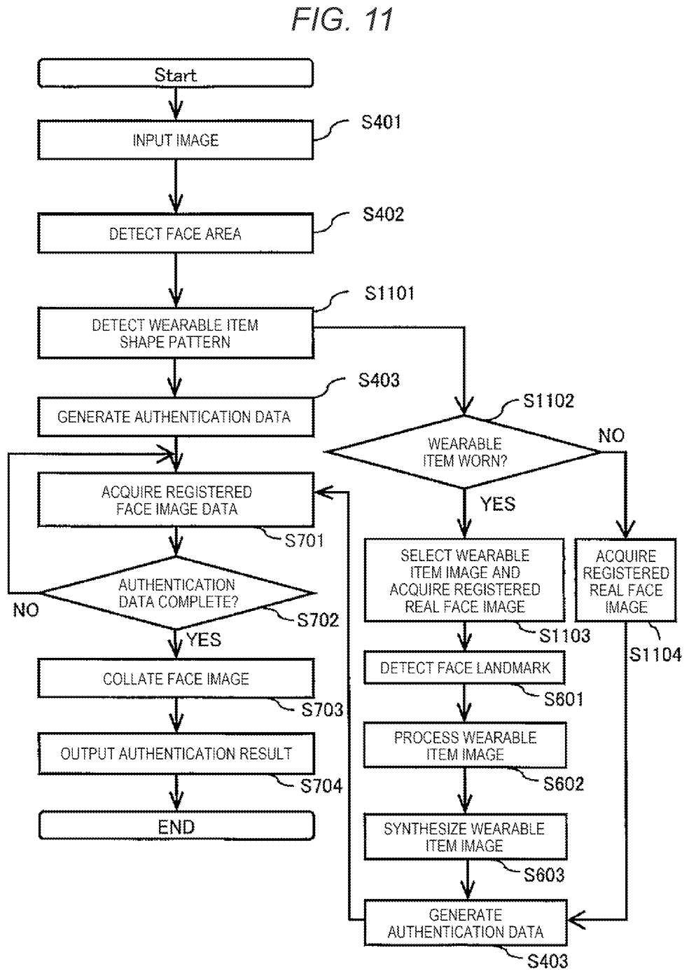

FIG. 11 is a flowchart illustrating a process at the time of face authentication in the second embodiment. The same step numbers as those described in the first embodiment are assigned the same step numbers, and the description thereof will be omitted. Hereinafter, the differences in the second embodiment will be mainly described.

The face image generated by the face area detection unit 310 in S402 is sent to the wearable item shape pattern detection unit 322. In S1101, the wearable item shape pattern detection unit 322 detects the wearable item shape from the face image. In S1102, the wearable item shape pattern detection unit 322 confirms the presence/absence of the wearable item based on the detection result. As an example of the pattern detection, a known method such as geometric shape pattern matching or a detector based on an NN model, or a combination thereof can be used. The presence/absence of the wearable item is determined such that, for example, in the case of the geometric shape pattern matching, it is determined that no wearable item is worn when there is no matching pattern. The detection method is not limited thereto as long as the shape and the presence/absence of the wearable item can be detected.

After S1101, the face image extracted from the captured image is sent to the authentication data generating unit 321 and the authentication data generating unit 321 generates the authentication data (S403).

When it is determined in S1102 that the wearable item is worn, in S1103, the wearable item image acquisition unit 323 selects the wearable item image 402 that best matches the detected shape pattern, acquires the wearable item image 402 from the data storage unit 400, and acquires the real face image 401 registered in advance. The acquired image is sent to the face landmark detection unit 324, and the face landmarks 401-1 are detected based on the real face image 401 (S601). Based on the detected face landmarks 401-1, the acquired wearable item image 402 is processed (S602), and the synthesized image 403 is generated to fit the real face image 401 (S603). The synthesized image 403 generated by the wearable item image processing unit 325 is sent to the authentication data generating unit 321 to generate the authentication data (S403). The individual is authenticated by collating the authentication data based on the face image extracted from the captured image at the time of authentication with the authentication data based on the generated synthesized image 403.

In S1102, when it is determined that no wearable item is worn at the time of authentication, the wearable item image acquisition unit 323 acquires only the registered real face image 401 without acquiring the wearable item image 402 (S1104), and the authentication data generating unit 321 generates the authentication data of only the real face image 401 (S403). By providing S1102, S601 to S603 can be skipped, and the collation speed can be increased.

Although not shown in the drawings, the wearable item image acquisition unit 323 may generate a wearable item image having the same shape pattern as the detected wearable item shape pattern instead of acquiring the wearable item image 402 that best matches the wearable item shape pattern, and use the wearable item image having the same shape pattern as the wearable item image 402. For example, when the user wears a mask at the time of authentication, a mask having the same shape as the detected mask may be generated and used as the wearable item image 402. This operation enables to cope with a wearable item of any shapes instead of preparing multiple wearable item images 402 in the data storage unit 400 in advance. The wearable item image 402 generated or extracted in this case may be registered in the data storage unit 400 as it is, such that the wearable item image 402 can be used when generating another synthesized image 403.

### Second Embodiment: Summary

The face authentication system 1 according to the second embodiment detects the wearable item shape pattern of the individual to be authenticated by the wearable item shape pattern detection unit 322, and acquires only the wearable item image corresponding to the shape pattern from the data storage unit 400 to generate the synthesized image. As a result, the number of the synthesized images used at the time of face authentication is reduced, which can speed up the authentication process. This is particularly useful when the range of the individuals to be authenticated is specified in advance, such as the 1:1 authentication. On the other hand, when personal identification is performed for an unspecified number of individuals as in the 1:N authentication, the right half of FIG. 11 is performed for all the individuals to be authenticated, and thus, the calculation load may become excessive. Thus, the second embodiment is particularly useful in the former.

### Third Embodiment

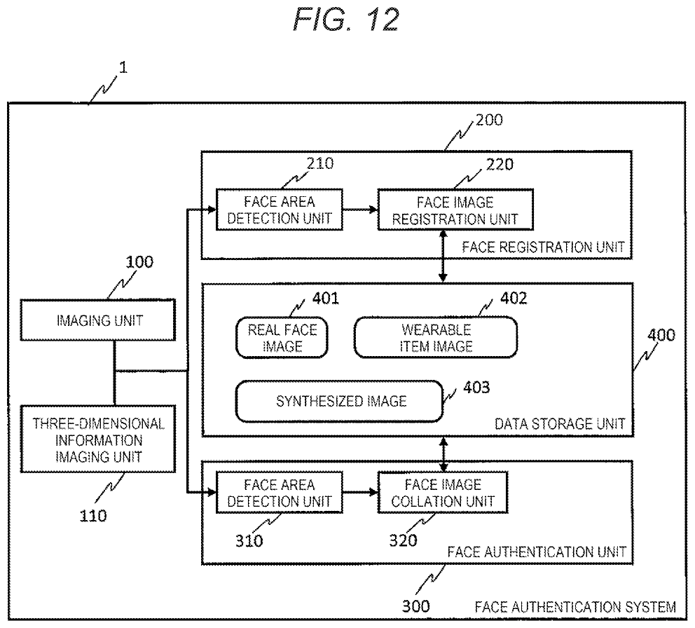

FIG. 12 is a configuration diagram of the face authentication system 1 according to a third embodiment. In the third embodiment, in addition to the configurations described in the first and second embodiments, a three-dimensional information imaging unit 110 is newly provided. The three-dimensional information imaging unit 110 acquires distance (depth) information (that is, a distance from the three-dimensional information imaging unit 110 to a captured location) in addition to luminance information of a captured subject. With this configuration, it is possible to process and synthesize a wearable item closer to the real world, improve accuracy of deriving a similarity, and improve the robustness when a face condition changes.

The three-dimensional information imaging unit 110 may be any device as long as the device can acquire the distance information such as a time-of-flat (ToF) camera or an infrared camera (IR camera). The imaging unit 100 and the three-dimensional information imaging unit 110 may be integrated to simultaneously acquire the luminance information and the distance information. Alternatively, the distance information may be acquired from parallax between pixels obtained from two imaging units by using two imaging units 100 that acquire the luminance information, such as stereo cameras or the like.

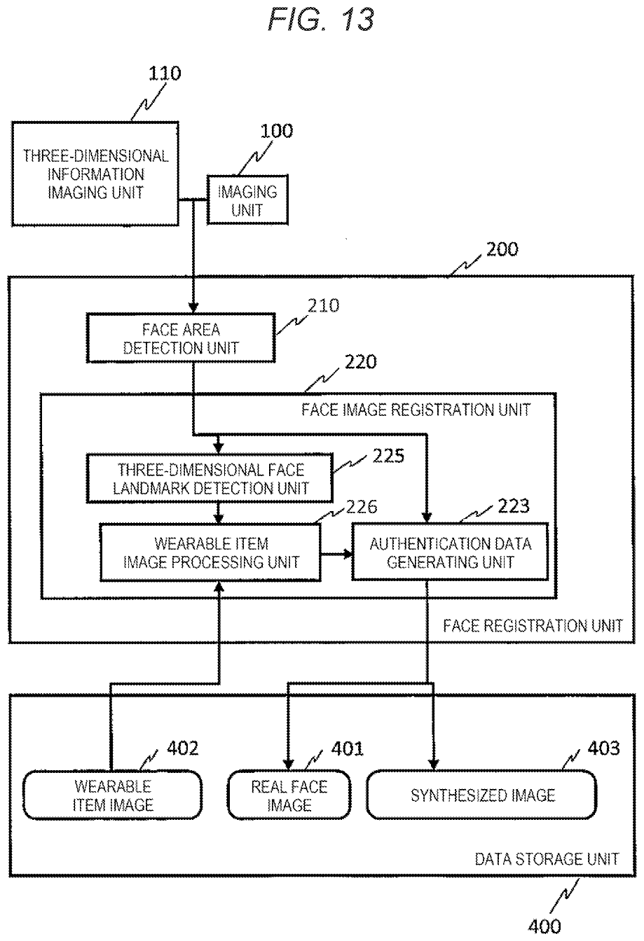

FIG. 13 is a diagram showing an internal processing block of the face authentication system 1. Compared to the first embodiment, the internal configuration of the face image registration unit 220 and the operation in the registration flow of the synthesized image 403 are different. Since the operations of other blocks are the same as those of the first embodiment, the internal process of the face image registration unit 220 and the operations in the registration flow of the synthesized image 403 will be mainly described.

The internal process of the face image registration unit 220 will be described. The face image registration unit 220 includes a three-dimensional face landmark detection unit 225, a wearable item image processing unit 226, and an authentication data generating unit 223. As compared to the first embodiment, the information to be processed is expanded to three dimensions including the distance information in addition to the luminance information.

The real face image generated by the face area detection unit 210 may be a three-dimensional image having the luminance information, and three-dimensional information of a distance image, or a combination of a two-dimensional image storing the luminance information and a two-dimensional image storing the distance information, and may be any form of image as long as the image has the three-dimensional information such as the luminance information and the distance information.

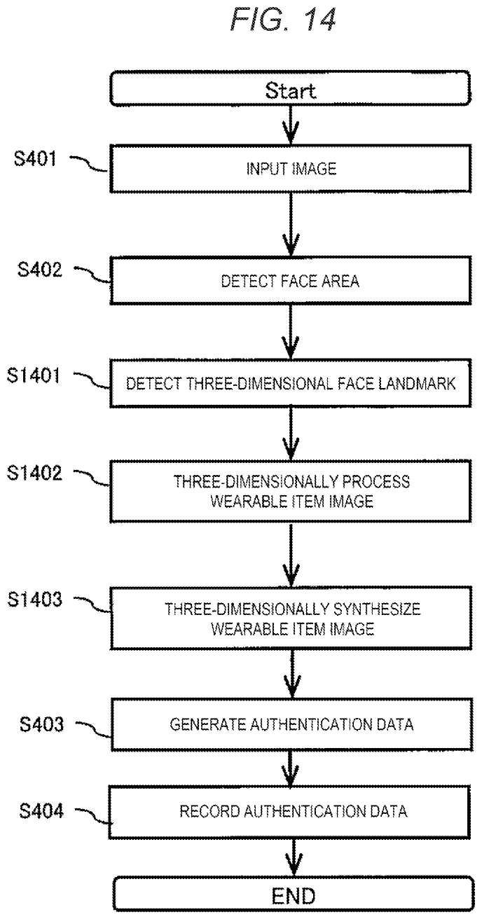

FIG. 14 is a flowchart illustrating a process of generating and registering the synthesized image 403 at the time of face registration. In the flowchart of FIG. 14, the steps having the same operations as those of the first embodiment are designated by the same reference numerals, and the description thereof will be omitted.

The real face image is sent to the three-dimensional face landmark detection unit 225. The three-dimensional face landmark detection unit 225 three-dimensionally detects the landmarks of the face based on the distance information acquired by the three-dimensional information imaging unit 110 (S1401). The method for detecting the three-dimensional face landmarks in S1401 may be a known method based on geometric pattern matching, a detector based on the NN model, or the like, but is not limited to these cases as long as the face landmarks can be three-dimensionally detected.

The detected three-dimensional face landmark information is sent to the wearable item image processing unit 226 together with the real face image generated by the face area detection unit 210. The wearable item image processing unit 226 acquires the wearable item image 402 from the data storage unit 400, three-dimensionally processes the wearable item based on the three-dimensional face landmarks (S1402), three-dimensionally synthesizes the wearable item to fit the face image (S1403), and sends the generated face image synthesized with the wearable item to the authentication data generating unit 223.

In S1402, the wearable item image 402 acquired from the data storage unit 400 may be either a three-dimensional image or a two-dimensional image as long as the wearable item can be three-dimensionally processed and synthesized with a three-dimensional face image. The real face image 401 and the synthesized image 403 recorded in the data storage unit 400 may be feature vectors generated by a feature extractor, three-dimensional images, two-dimensional images converted from three-dimensional images, or any combination thereof. When generating the feature vectors, the images to be input to the feature extractor may be in the form of three-dimensional images or two-dimensional images, or a combination thereof may be input to the feature extractor to generate integrated feature vectors.

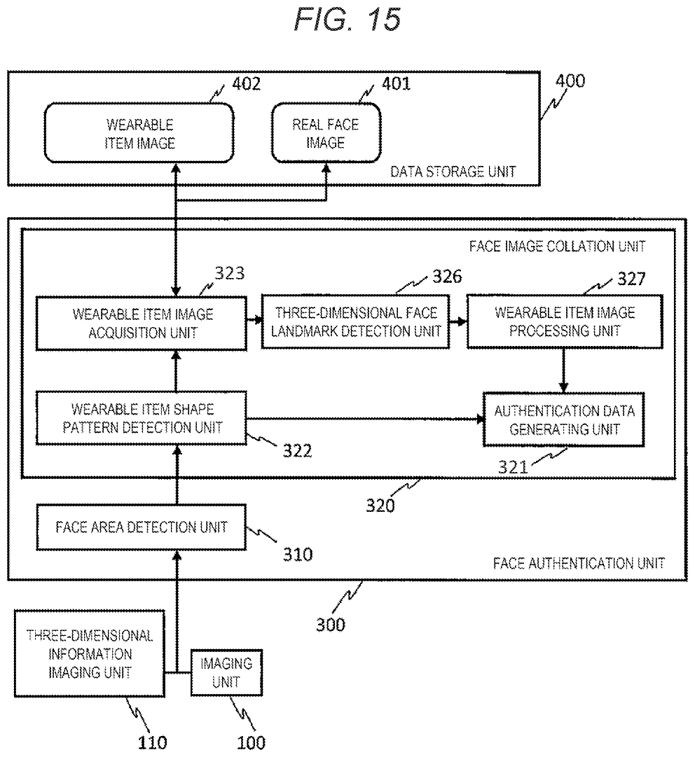

FIG. 15 is a configuration diagram of the face authentication unit 300 in the third embodiment. Compared to FIG. 9 of the second embodiment, the internal process of the face image collation unit 320 is different, and the operations of the other blocks are the same as those of the second embodiment. In the third embodiment, the face landmark detection unit 324 and the wearable item image processing unit 325 in FIG. 9 are replaced with a three-dimensional face landmark detection unit 326 and a wearable item image processing unit 327, respectively.

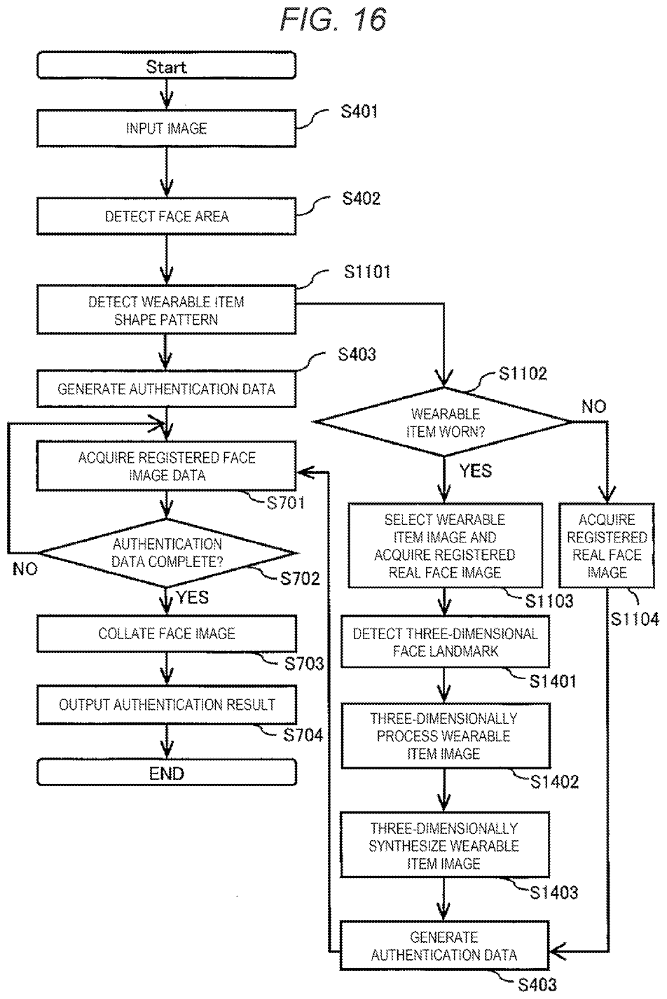

FIG. 16 is a flowchart showing operations at the time of face authentication in the third embodiment. In the flowchart of FIG. 16, the steps having the same operations as those of the second embodiment are designated by the same reference numerals, and the description thereof will be omitted.

In S1102, when it is determined that the wearable item is worn, the real face image 401 and the wearable item image 402 (S1103) acquired by the wearable item image acquisition unit 323 are sent to the three-dimensional face landmark detection unit 326, and the face landmarks are three-dimensionally detected (S1401). The detected three-dimensional face landmark information, the real face image 401, and the wearable item image 402 are sent to the wearable item image processing unit 327. The wearable item image 402 is three-dimensionally processed based on the three-dimensional face landmark information (S1402), and is three-dimensionally synthesized with the real face image 401 to fit the real face image 401 (S1403).

### Third Embodiment: Summary

Compared to the case where the face landmarks are two-dimensionally detected and the wearable item is two-dimensionally synthesized in the first and second embodiments, since the face authentication system 1 according to the third embodiment three-dimensionally processes and synthesizes the wearable item image based on the three-dimensional face landmarks, and can thus realistically reproduce the curved surface portions of the wearable item even when the face orientation changes, and can synthesize the wearable item image 402 with the real face image 401 with higher accuracy. This enables to improve the accuracy of deriving the similarity by realistically reproducing the wearing state of the wearable item and to improve the robustness of the similarity by the face orientation. Further, at the time of face authentication, the distance information is also included in matching data, so that the authentication accuracy of the real face image alone can be improved as well as the case where the wearable item is worn.

### Fourth Embodiment

In a fourth embodiment of the invention, a configuration for improving the collation efficiency and speeding up the collation process in the first embodiment will be described. In the first embodiment, as a variation of the wearable item increases, the number of synthesized images 403 registered in the data storage unit 400 also increases proportionally (especially in the 1:N authentication, the registered face data increases depending on the number of registered individuals). Therefore, sequentially collating all the registered face data stored in the data storage unit 400 increases the time required for collation. The fourth embodiment is intended to speed up the collation process.

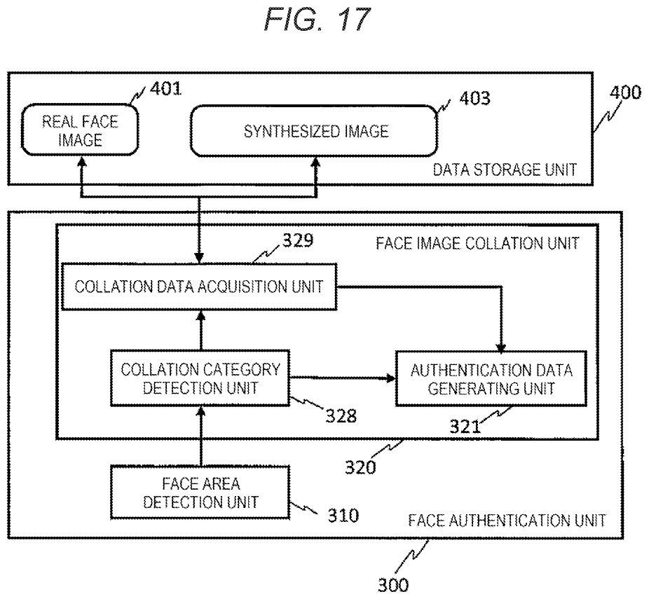

FIG. 17 is a configuration diagram of the face authentication unit 300 in the fourth embodiment. The difference from the first embodiment is that a collation category detection unit 328 and a collation data acquisition unit 329 are added in the face image collation unit 320. The merits of adding the collation category detection unit 328 include, for example, that the presence/absence of the wearable item (whether a real face or wearing a wearable item), the type of the wearable item (mask, goggles, glasses, hat, etc.), attributes of the individual (age, gender, etc.), the face orientation (a combination of one or more of yaw, roll, and pitch), and the like can be detected in advance, and the category of the registered face data used for collation can be narrowed down to the category corresponding to the detected attributes. As a result, the collation efficiency is improved, and the collation time can be reduced as compared to the case where all the registered images are sequentially authenticated.

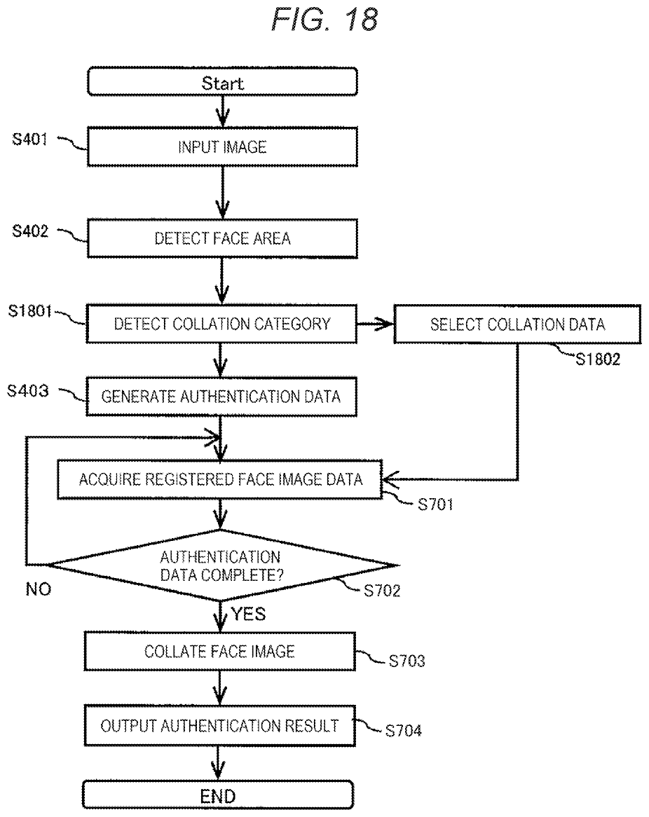

FIG. 18 is a flowchart illustrating operations at the time of authentication in the fourth embodiment. In the flowchart of FIG. 18, the steps having the same operations as those of the first embodiment are designated by the same reference numerals, and the description thereof will be omitted.

The face image generated by the face area detection unit 310 is sent to the collation category detection unit 328. The collation category detection unit 328 detects the category of the face image (S1801). Examples of collation categories include the presence/absence of the wearable item, the type of the wearable item, the attributes of the individual, the face orientation, or a combination thereof. As the category detection method, known methods such as geometric shape pattern matching, a detector based on an NN model, or a combination thereof can be used. Two or more NN model detectors may be combined. Examples thereof include a combination of an NN model detector that determines the type of a wearable item and a dedicated NN model detector that determines the classification of gender. Information of the detected category is sent to the collation data acquisition unit 329. The collation data acquisition unit 329 acquires a registered image (real face image 401 or synthesized image 403) suitable for the category detected from the data storage unit 400 (S1802), and sends the registered image to the authentication data generating unit 321.

### Fourth Embodiment: Summary

The face authentication system 1 according to the fourth embodiment acquires only the real face image 401 or the synthesized image 403 corresponding to the type of the wearable item or the attributes of the individual to be authenticated from the data storage unit 400, and uses the image to perform face authentication. As a result, the registered face data used at the time of collation can be narrowed down, and the number of collations can be reduced, so that the collation efficiency can be improved, and the collation speed can be increased.

### Fifth Embodiment

A fifth embodiment of the invention will describe a configuration in which robustness to face orientation is improved by changing the face orientation in order to carry out face authentication more robust to the face orientation. In addition, in applications such as simultaneous face authentication of a plurality of users using signage and face authentication using surveillance cameras, the face orientation at the time of authentication is not limited to the front face, and the face orientation angle varies greatly. Thus, for example, authentication is required to be performed when the face is facing diagonally. The fifth embodiment is intended to further improve the authentication robustness in such a case.

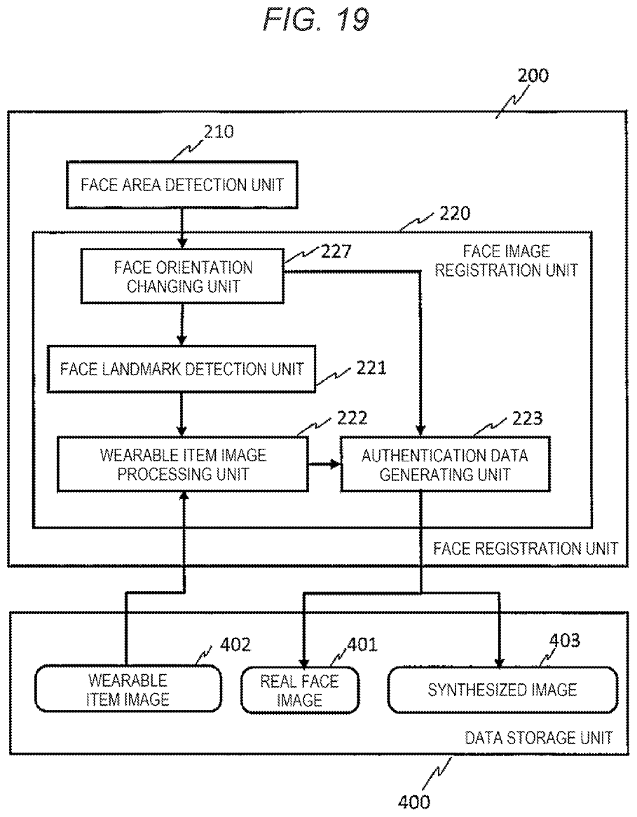

FIG. 19 is a configuration diagram of the face registration unit 200 in the fifth embodiment. The difference from the first embodiment is that a face orientation changing unit 227 is added in the face image registration unit 220. The merit of adding the face orientation changing unit 227 is that a large number of real face images 401 having various face orientations and the synthesized images 403 can be stored in the data storage unit 400 in advance, and highly accurate authentication can be implemented regardless of the face orientation at the time of authentication. The description of the blocks common to the first embodiment will be omitted, and the face orientation changing unit 227 having different operations will be described below.

The real face image generated by the face area detection unit 210 is first sent to the face orientation changing unit 227. The face orientation changing unit 227 changes the face orientation angle of the input face image. The face image whose face orientation has been changed is sent to the authentication data generating unit 223 as it is when the real face image 401 is to be generated, and is sent to the face landmark detection unit 221 when the synthesized image 403 is to be generated.

The face orientation changing unit 227 can use a known method such as affine transformation or face orientation transformation by non-rigid body deformation method based on FFD. In the non-rigid body deformation method based on FFD, the face image is provided with a control point thereon, and the face image is deformed by moving the control point. When a face landmark is used as the control point, the face landmark detection unit 221 may be arranged previous to the face orientation changing unit 227, so that the face landmark detection is performed first and then the face orientation is changed. The face orientation changing unit 227 may generate face images in a plurality of orientations, and then complement and generate face images in the middle orientation from the plurality of face images having different face orientations. For example, a face image diagonally oriented in the middle is generated from the front and sideways face images.

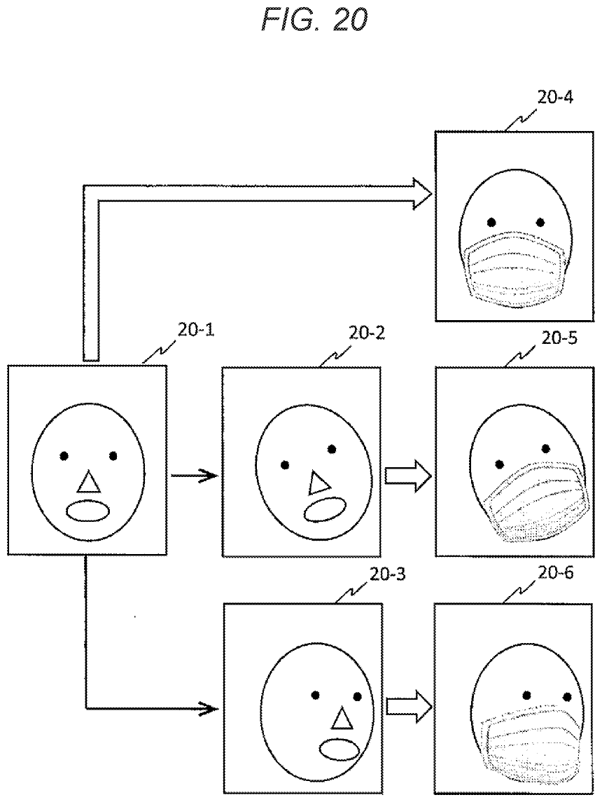

FIG. 20 is a diagram showing the effect of the fifth embodiment. The diagram shows an example in which the face orientation is changed in two directions by the face orientation changing unit 227, and then a mask image is synthesized as the wearable item image 402. Based on a real face image 20-1 generated by the face area detection unit 210, by changing the face orientation, a real face image 20-2 tilted at an angle in the roll direction and a real face image 20-3 tilted at an angle in the yaw direction are generated. The face landmarks are detected, and the wearable item image is processed and synthesized to fit the face orientation for each of the real face images 20-1, 20-2, and 20-3, such that wearing-item-synthesized face images 20-4, 20-5, 20-6 are generated, respectively. By recording the images 20-1 to 20-6 in the data storage unit 400, face authentication corresponding to the face orientation angle in three directions including before and after the face orientation change at the time of authentication is possible. In the example of FIG. 20, the face orientation is changed in two directions, but may also be changed in any direction, and the number thereof is not limited.

The fifth embodiment may speed up the collation at the time of authentication in combination with the fourth embodiment. In a collation category detection at the time of face authentication, the collation efficiency can be improved by detecting the face orientation and acquiring the registered face data having the same face orientation as the detected face orientation from the data storage unit 400.

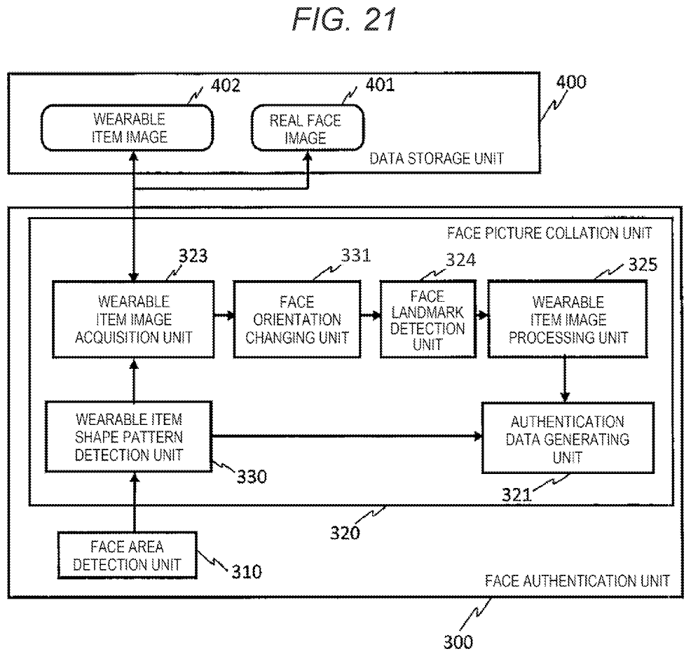

FIG. 21 is a configuration diagram of the face authentication unit 300 in the fifth embodiment. The difference from the second embodiment is that a face orientation changing unit 331 is added to the face image collation unit 320, and the wearable item shape pattern detection unit 322 is replaced with a wearable item shape pattern detection unit 330. The merit of adding the face orientation changing unit 331 as compared to the second embodiment is that the face orientation of the face image registered in the data storage unit 400 can be changed according to the face orientation at the time of authentication. As a result, it is possible to generate a synthesized image having the same face orientation angle as the face orientation angle of the user at the time of authentication, so that the accuracy of deriving the similarity is improved. Hereinafter, the description of the blocks common to the second embodiment will be omitted, and the blocks having different operations will be described.

From the face image generated by the face area detection unit 310, the wearable item shape pattern detection unit 330 detects patterns of the worn wearable item and the face orientation at the time of authentication. Based on detected face orientation information, the face orientation changing unit 331 changes the acquired real face image 401. The real face image 401 whose face orientation is changed according to the face orientation angle at the time of authentication is sent to the face landmark detection unit 324 for processing and synthesizing the wearable item. If the user does not wear the wearable item at the time of authentication, the real face image 401 whose face orientation is changed is sent to the authentication data generating unit 321 as it is.

The wearable item shape pattern detection unit 330 also detects the face orientation in addition to the detection of the wearable item shape pattern described in S1101 of FIG. 11. The face orientation detection may be performed with a known method such as a method of detecting face landmarks and comparing the face landmarks with face landmarks when facing the front at a predetermined point to estimate the face orientation angle, a detector based on an NN model, or the like.

### Fifth Embodiment: Summary

In both cases of the first embodiment and the second embodiment, the face authentication system 1 according to the fifth embodiment can flexibly change the face orientation angles of the real face image 401 and the synthesized image 403 used at the time of authentication by the face orientation changing unit 331, and then store the images in the data storage unit 400 in advance. As a result, it is possible to implement a face authentication system that enables highly accurate face authentication and is more robust to the face orientation angle even when the face orientation of the user faces various directions at the time of authentication.

### Modifications of Invention

The invention is not limited to the embodiments described above, and includes various modifications. For example, the embodiments described above have been described in detail for easily understanding the invention, and the invention is not necessarily limited to those including all the configurations described above. Further, a part of the configuration of one embodiment can be replaced with the configuration of another embodiment, and the configuration of another embodiment can be added to the configuration of one embodiment. In addition, a part of the configurations of each embodiment could be added, deleted, or replaced with other configurations.

The above embodiments have described an example in which the face registration unit 200 and the face authentication unit 300 are connected to the same imaging unit 100, but the face registration unit 200 and the face authentication unit 300 may be each provided with an imaging unit 100.

The above embodiments have shown an integral face authentication system 1, but the imaging unit 100, the face registration unit 200, the face authentication unit 300, and the data storage unit 400 may be arranged in different locations in space, and may be configured to wirelessly communicate data with the data base station 2.

In the above embodiments, the authentication data generating unit may extract the features of the synthesized image by using a feature extractor that differs depending on the type of wearable item (including the presence/absence of the wearable item), attributes of an individual, face orientation, or a combination thereof. For example, in the first embodiment, a feature extractor for real face image is used when the individual to be authenticated does not wear a wearable item, and a feature extractor for masks is used when the individual to be authenticated wears a mask. Alternatively, in the fourth embodiment, a feature extractor for males is used when the attribute of the individual to be authenticated is “male”. Alternatively, a feature extractor for masks and males is used when the individual to be authenticated is “mask, male”. Similarly, when registering the face image, a feature extractor that differs depending on the type of the wearable item and the attributes of the individual may be used.

In the embodiments described above, the face registration unit 200 and the face authentication unit 300 (and each functional unit arranged as an internal block thereof) may be implemented by hardware such as a circuit device that implements these functions, or may also be provided by executing software that implements these functions by an arithmetic unit (for example, central processing unit (CPU)).

What is claimed is:

1. A face authentication system for identifying an individual by using a face image, the face authentication system comprising:
a synthesis unit configured to generate a synthesized image by synthesizing a wearable item image with a real face image of the individual, the wearable item image being an image of a wearable item worn by the individual; and
a face authentication unit configured to identify the individual by using the synthesized image, wherein
the synthesis unit is configured to generate the synthesized image by deforming the wearable item image to fit a face shape of the individual.

2. The face authentication system according to claim 1, wherein
the synthesis unit is configured to deform the wearable item image to fit the face shape of the individual with reference to a landmark on the real face image.

3. The face authentication system according to claim 2, wherein
the synthesis unit is configured to detect, according to the landmark, at least one of a yaw angle, a roll angle, or a pitch angle at which the face image of the individual is rotated with reference to a time when the individual faces the front, and
the synthesis unit is configured to deform the wearable item image to fit the face shape of the individual by rotating the wearable item image according to the detected angle.

4. The face authentication system according to claim 3, wherein
the synthesis unit is configured to deform the wearable item image such that a vertical size of the wearable item image matches a vertical size of a position of wearing the wearable item among landmarks,
the synthesis unit is configured to deform the wearable item image such that a horizontal size of the wearable item image matches a horizontal size of the position of wearing the wearable item among the landmarks, and
the synthesis unit is configured to deform the wearable item image for each of a plurality of divided areas of the wearable item image to match the vertical size of the wearable item image with the vertical size of the wearing position, and match the horizontal size of the wearable item image with the horizontal size of the wearing position.

5. The face authentication system according to claim 1, further comprising:
a wearable item shape pattern detection unit configured to detect a wearable item shape pattern from the face image of the individual, wherein
the face authentication unit is configured to identify the individual by using the synthesized image when the face authentication unit detects the wearable item shape pattern from the face image, and
the face authentication unit is configured to identify the individual by using the real face image when the face authentication unit does not detect the wearable item shape pattern from the face image.

6. The face authentication system according to claim 5, further comprising:
a data storage unit configured to store a plurality of types of wearable item images, wherein
the face authentication unit is configured to acquire only the wearable item image corresponding to the detected wearable item shape pattern from the data storage unit among the plurality of types of wearable item images, and
the synthesis unit is configured to generate the synthesized image by using only the wearable item image acquired from the data storage unit among the plurality of types of wearable item images.

7. The face authentication system according to claim 2, wherein
the synthesis unit is configured to acquire, as the real face image, a three-dimensional image including luminance information and distance information of the face image of the individual,
the synthesis unit is configured to identify, as the landmark, a feature point in a three-dimensional coordinate system on the real face image, and
the synthesis unit is configured to fit the wearable item image with the face shape of the individual by transforming the wearable item image in the three-dimensional coordinate system with reference to the landmark in the three-dimensional coordinate system.

8. The face authentication system according to claim 1, further comprising:
a data storage unit configured to store the synthesized image for each type of the wearable item; and
a category detection unit configured to detect the type of the wearable item, wherein
the synthesis unit is configured to acquire only the synthesized image corresponding to the detected type of the wearable item from the data storage unit, and
the face authentication unit is configured to identify the individual by using the synthesized image acquired from the data storage unit.

9. The face authentication system according to claim 1, further comprising:
a data storage unit configured to store the real face image and the synthesized image for each individual attribute; and
a category detection unit configured to detect an attribute of the individual, wherein
the synthesis unit is configured to acquire only the real face image corresponding to the detected attribute of the individual or the synthesized image corresponding to the detected attribute of the individual from the data storage unit, and
the face authentication unit is configured to identify the individual by using the real face image or the synthesized image acquired from the data storage unit.

10. The face authentication system according to claim 1, further comprising:
a face orientation changing unit configured to change a face orientation of the real face image, wherein
the synthesis unit is configured to perform the same orientation change as the face orientation changed by the face orientation changing unit on the wearable item image, and
the synthesis unit is configured to generate the synthesized image by synthesizing the wearable item image applied with the orientation change with respect to the real face image.

11. The face authentication system according to claim 1, further comprising:
a data storage unit configured to store the real face image, wherein
the data storage unit is configured to store at least the real face image in which the individual faces the front and the real face image in which the individual tilts a face at an angle.

12. The face authentication system according to claim 1, wherein
the wearable item is an object that covers at least a part of a face of the individual when worn by the individual.

13. The face authentication system according to claim 12, wherein
the wearable item is at least one of a mask, glasses, goggles, or a hat.

14. The face authentication system according to claim 1, further comprising:
an authentication data generating unit configured to extract a feature of the synthesized image as authentication data used to identify the individual, wherein
the face authentication unit is configured to identify the individual by comparing a feature of the face image of the individual with the feature extracted from the synthesized image.

15. The face authentication system according to claim 14, wherein
the authentication data generating unit is configured to extract the feature of the synthesized image by using a feature extractor corresponding to a type of the wearable item, a feature extractor corresponding to an attribute of the individual, or a feature extractor corresponding to a face orientation.
